(19) United States
(12) Patent Application Publication
(10) Pub. No.: US 2026/0254519 A1
(43) Pub. Date: Aug. 27, 2026

(54) METHOD AND DEVICE FOR BEAM MANAGEMENT IN SIDELINK COMMUNICATION

(71) Applicants: HYUNDAI MOTOR COMPANY, Seoul (KR); KIA CORPORATION, Seoul (KR); Gachon University Industry-Academic Cooperation Foundation, Seongnam-si, Gyeonggi-do (KR)

(72) Inventors: Ui Hyun Hong, Hwaseong-si, Gyeonggi-do (KR); Hyuk Min Son, Seoul (KR)

(73) Assignees: HYUNDAI MOTOR COMPANY, Seoul (KR); KIA CORPORATION, Seoul (KR); Gachon University Industry-Academic Cooperation Foundation, Seongnam-si, Gyeonggi-do (KR)

(21) Appl. No.: 18/992,160

(22) PCT Filed: Sep. 6, 2023
(86) PCT No.: PCT/KR2023/013333

§ 371 Date: Jan. 7, 2025

(30) Foreign Application Priority Data
Sep. 6, 2022 (KR) 10-2022-0112871

(51) Int. Cl. H04B 7/06; H04B 17/318; H04L 5/00; H04W 72/23

(52) U.S. Cl. CPC H04B 7/06954; H04B 7/0626; H04B 7/0639; H04B 17/328; H04L 5/0016; H04L 5/005; H04W 72/23

(57) ABSTRACT

A method of a first UE and a second UE in sidelink communication is disclosed. The method of the first UE according to the present disclosure may comprise the steps of: receiving resource set information of a CSI-RS related to beam management from a base station; determining a first resource and a CSI-RS pattern of the CSI-RS for beam management on the basis of the resource set information of the CSI-RS; and configuring sidelink (SL) control information (SCI) including information related to sidelink (SL) data, the first resource, and the CSI-RS pattern.

### TECHNICAL FIELD

The present disclosure relates to a sidelink communication technique, and more particularly, to a technique for managing beams used in sidelink communication.

### BACKGROUND ART

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, no standard techniques have been developed for sidelink FR2 licensed band beam management. Additionally, the need for developing sidelink FR2 licensed band beam management has been mentioned in the NR sidelink evolution under Rel. 18 of the 3GPP standard meetings.

Accordingly, there is a need for a method and apparatus for beam management in an FR2 licensed band in sidelink communication.

### DISCLOSURE

### Technical Problem

The present disclosure is directed to providing a method and an apparatus for managing beams of an FR2 licensed band in sidelink communication.

### Technical Solution

A method of a first user equipment (UE), according to an exemplary embodiment of the present disclosure, may comprise: receiving, from a base station, information on a channel state information-reference signal (CSI-RS) resource set related to beam management; determining a first resource and a CSI-RS pattern of a CSI-RS for beam management based on the information on the CSI-RS resource set; configuring sidelink (SL) data and SL control information (SCI) including information related to the first resource and the CSI-RS pattern; arranging the CSI-RS for beam management in a first slot based on the first resource and the CSI-RS pattern; and transmitting the CSI-RS, the SL data, and the SCI to a second UE through a preconfigured transmission beam in the first slot.

The SCI may further include at least one of density information of the CSI-RS or information of a type of CSI report to be reported by the second UE.

The method may further comprise: receiving, from the second UE, a beam index (BI) for a transmission beam of the first UE and beam quality information (BQI) for the transmission beam of the first UE, based on information of the type of the CSI report; and determining whether to switch a transmission beam for transmitting data to the second UE based on the received BI and the received BQI.

The BQI may be one of a Reference Signal Received Power (RSRP) or Layer 1 (L1)-RSRP.

The method may further comprise: receiving, from the base station, first slot configuration information including position information of symbols through which a Physical Sidelink Control Channel (PSCCH) is transmitted and position information of symbols through which a Physical Sidelink Shared Channel (PSSCH) is transmitted, wherein the SCI may indicate at least one symbol among the symbols through which the PSSCH is transmitted as the first resource.

When the first slot configuration information indicates that a PSCCH and the PSSCH are to be allocated together in at least one symbol of the first slot, the first resource indicated by the SCI may be at least one symbol among symbols excluding symbol(s) of the PSSCH allocated together with the PSCCH.

The method may further comprise: receiving, from the base station, first slot configuration information including position information of symbols through which a PSCCH is transmitted, position information of symbols through which a PSSCH is transmitted, and position information of symbols through which the CSI-RS is transmitted, wherein the first resource indicated by the SCI may be at least one symbol among the symbols through which the CSI-RS is transmitted.

The information related to the CSI-RS pattern may indicate at least one of code division multiplexing (CDM) of the CSI-RS, time division multiplexing (TDM) of the CSI-RS, or frequency division multiplexing (FDM) of the CSI-RS, and may include information on a number of ports through which the CSI-RS is transmitted.

A method of a second user equipment (UE), according to an exemplary embodiment of the present disclosure, may comprise: receiving, from a base station, information on a channel state information-reference signal (CSI-RS) resource set related to beam management; receiving sidelink control information (SCI) from a first UE; measuring a first CSI-RS for beam management based on the information on the CSI-RS resource set and the SCI; generating a beam index (BI) of a transmission beam of the first UE and beam quality information (BQI) of the transmission beam of the first UE based on the measured first CSI-RS; and reporting the BI and the BQI to the first UE.

The SCI may further include at least one of information related to sidelink (SL) data, information of a first resource of the first CSI-RS, density information of the first CSI-RS, or information of a transmission pattern of the first CSI-RS.

The information of the transmission pattern of the first CSI-RS may indicate at least one of code division multiplexing (CDM) of the first CSI-RS, time division multiplexing (TDM) of the first CSI-RS, or frequency division multiplexing (FDM) of the first CSI-RS, and may include information on a number of ports through which the first CSI-RS is transmitted.

The method may further comprise: receiving, from the base station, first slot configuration information including position information of symbols through which a Physical Sidelink Control Channel (PSCCH) is transmitted and position information of symbols through which a Physical Sidelink Shared Channel (PSSCH) is transmitted, wherein the SCI may indicate at least one symbol among the symbols through which the PSSCH is transmitted as a first resource for transmitting the first CSI-RS.

When the first slot configuration information indicates that a PSCCH and the PSSCH are to be allocated together in at least one symbol of the first slot, the first resource indicated by the SCI may be at least one symbol among symbols excluding symbol(s) of the PSSCH allocated together with the PSCCH.

The method may further comprise: receiving, from the base station, first slot configuration information including position information of symbols through which a PSCCH is transmitted, position information of symbols through which a PSSCH is transmitted, and position information of symbols through which the first CSI-RS is transmitted, wherein the SCI may indicate at least one symbol among the symbols through which the PSSCH is transmitted as a position at which the first CSI-RS is transmitted.

A first user equipment (UE), according to an exemplary embodiment of the present disclosure, may comprise at least one processor, wherein the at least one processor causes the first UE to perform: receiving, from a base station, information on a channel state information-reference signal (CSI-RS) resource set related to beam management; determining a first resource and a CSI-RS pattern of a CSI-RS for beam management based on the information on the CSI-RS resource set; configuring sidelink (SL) data and SL control information (SCI) including information related to the first resource and the CSI-RS pattern; arranging the CSI-RS for beam management in a first slot based on the first resource and the CSI-RS pattern; and transmitting the CSI-RS, the SL data, and the SCI to a second UE through a preconfigured transmission beam in the first slot.

The SCI may further include at least one of density information of the CSI-RS or information of a type of CSI report to be reported by the second UE.

The at least one processor may further cause the first UE to perform: receiving, from the second UE, a beam index (BI) for a transmission beam of the first UE and beam quality information (BQI) for the transmission beam of the first UE, based on information of the type of the CSI report; and determining whether to switch a transmission beam for transmitting data to the second UE based on the received BI and the received BQI.

The at least one processor may further cause the first UE to perform: receiving, from the base station, first slot configuration information including position information of symbols through which a Physical Sidelink Control Channel (PSCCH) is transmitted and position information of symbols through which a Physical Sidelink Shared Channel (PSSCH) is transmitted, wherein the SCI may indicate at least one symbol among the symbols through which the PSSCH is transmitted as the first resource.

When the first slot configuration information indicates that a PSCCH and the PSSCH are to be allocated together in at least one symbol of the first slot, the first resource indicated by the SCI may be at least one symbol among symbols excluding symbol(s) of the PSSCH allocated together with the PSCCH.

The at least one processor may further cause the first UE to perform: receiving, from the base station, first slot configuration information including position information of symbols through which a PSCCH is transmitted, position information of symbols through which a PSSCH is transmitted, and position information of symbols through which the CSI-RS is transmitted, wherein the first resource indicated by the SCI may be at least one symbol among the symbols through which the CSI-RS is transmitted.

### Advantageous Effects

According to the present disclosure, beams used for communication between terminals in sidelink communication can be managed. In particular, using beam management methods according to the present disclosure, beam management can be performed without affecting a PSCCH.

Additionally, during beam management according to the present disclosure, it can be determined which beam among a first beam currently in use for communication and a second beam exhibits better quality, and the beam management can be performed based on the determination. Specifically, the beam management methods according to the present disclosure can be provided as beam management methods for an FR2 licensed band.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9A is a conceptual diagram illustrating a first exemplary embodiment of a PSSCH/PSCCH slot structure with a normal CP.

FIG. 9B is a conceptual diagram illustrating a second exemplary embodiment of a SL slot structure where PSCCH is allocated to a single symbol.

FIG. 9C is a conceptual diagram illustrating a third exemplary embodiment of a SL slot structure where both PSCCH and PSSCH are mapped to the second symbol.

FIG. 9D is a conceptual diagram illustrating a fourth exemplary embodiment where positions of symbols for transmitting CSI-RS for beam management are determined.

FIG. 9E is a conceptual diagram illustrating a fifth exemplary embodiment where positions of symbols for transmitting CSI-RS for beam management are determined.

FIG. 10 is a flowchart illustrating a case where a SL slot for beam management is configured and used for communication.

FIG. 11A is a conceptual diagram illustrating a first exemplary embodiment where CSI-RS is transmitted through a 1-port in a single slot.

FIG. 11B is a conceptual diagram illustrating a second exemplary embodiment where CSI-RS is transmitted through a 1-port in a single slot.

FIG. 11C is a conceptual diagram illustrating a third exemplary embodiment where CSI-RS is transmitted through 2-ports in a single slot.

FIG. 11D is a conceptual diagram illustrating a fourth exemplary embodiment where CSI-RS is transmitted through 2-ports within a single slot.

FIG. 11E is a conceptual diagram illustrating a fifth exemplary embodiment where a CSI-RS is transmitted through 2 ports in a FDM scheme within a single slot.

FIG. 11F is a conceptual diagram illustrating a sixth exemplary embodiment where CSI-RS is transmitted through 2-ports in a FDM scheme within a single slot.

FIG. 12 is a flowchart illustrating determination of a CSI-RS transmission pattern for beam management in SL communication according to the second exemplary embodiment of the present disclosure.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g. master information block (MIB), system information block (SIB)) and/or an RRC message. The MAC signaling may refer to an operation of transmitting and receiving a MAC control element (CE). The PHY signaling may refer to an operation of transmitting and receiving control information (e.g. downlink control information (DCI), uplink control information (UCI), or sidelink control information (SCI)).

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g. 4G communication networks, 5G communication networks, and/or 6G communication networks). Here, ‘communication network’ may be used interchangeably with a term ‘communication system’.

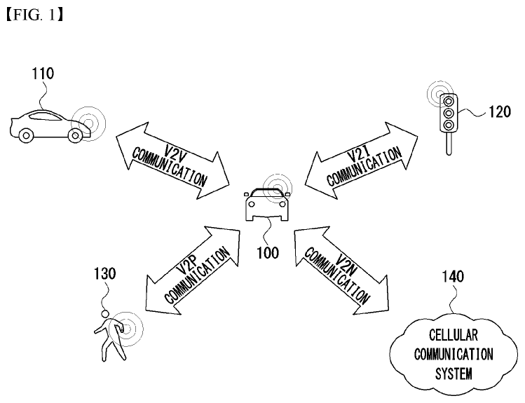

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g. communication network) 140, and the V2X communications supported by the communication system 140 may be referred to as ‘Cellular-V2X (C-V2X) communications’. Here, the communication system 140 may include the 4G communication system (e.g. LTE communication system or LTE-A communication system), 5G communication system (e.g. NR communication system), and the like.

The V2V communications may include communications between a first vehicle 100 (e.g. a communication node located in the vehicle 100) and a second vehicle 110 (e.g. a communication node located in the vehicle 110). Various driving information such as velocity, heading, time, position, and the like may be exchanged between the vehicles 100 and 110 through the V2V communications. For example, autonomous driving (e.g. platooning) may be supported based on the driving information exchanged through the V2V communications. The V2V communications supported by the communication system 140 may be performed based on sidelink communication technologies (e.g. Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g. road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g. ProSe and D2D communication technologies, and the like). In this case, the communications between the vehicle 100 and the infrastructure 120 may be performed using at least one sidelink channel.

The V2P communications may include communications between the first vehicle 100 (e.g. the communication node located in the vehicle 100) and a person 130 (e.g. a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g. ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g. the communication node located in the vehicle 100) and the communication system (e.g. communication network) 140. The V2N communications may be performed based on the 4G communication technology (e.g. LTE or LTE-A specified as the 3GPP standards) or the 5G communication technology (e.g. NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

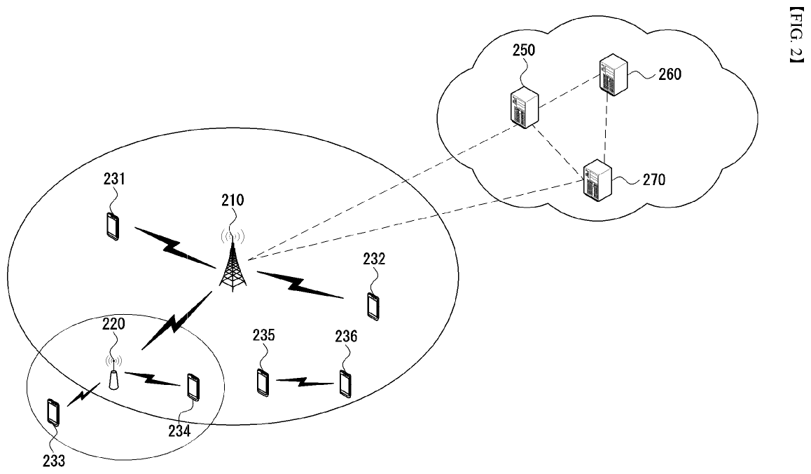

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g. a V2V network slice, a V2I network slice, a V2P network slice, a V2N network slice, etc.) may be configured, and the V2X communications may be supported through the V2X network slices configured in the core network.

The communication nodes (e.g. base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g. base station, relay, UE, S-GW, P-GW, MME, UPF, SMF, AMF, etc.) constituting the communication system may be configured as follows.

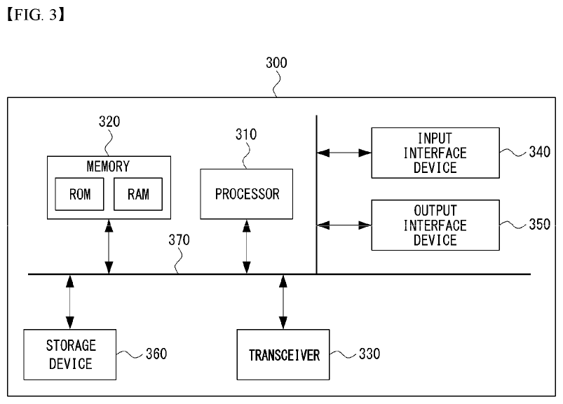

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g. single user (SU)-MIMO, multi-user (MU)-MIMO, massive MIMO, etc.), coordinated multipoint (CoMP) communication technologies, carrier aggregation (CA) communication technologies, unlicensed band communication technologies (e.g. Licensed Assisted Access (LAA), enhanced LAA (eLAA), etc.), sidelink communication technologies (e.g. ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

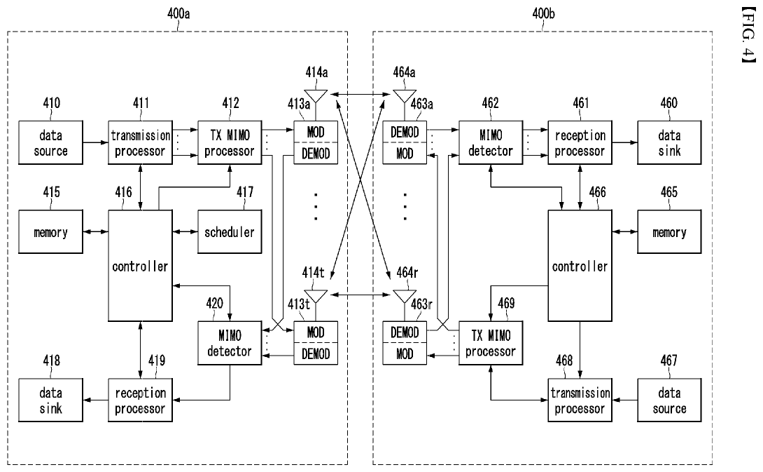

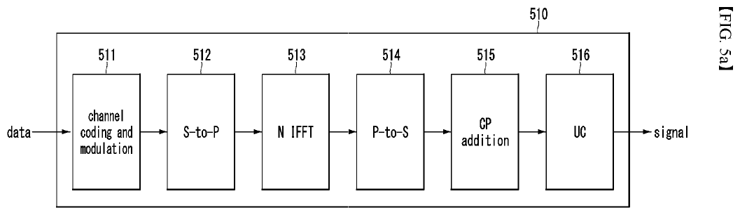

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g. ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g. the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of base | Out of coverage of base |
| | station 210 | station 210 |
| B | In coverage of base | Out of coverage of base |
| | station 210 | station 210 |
| C | In coverage of base | In coverage of base |
| | station 210 | station 210 |
| D | In coverage of base | In coverage of other base |
| | station 210 | station |

Meanwhile, a user plane protocol stack of the UEs (e.g. the UEs 235 and 236) performing sidelink communications may be configured as follows.

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g. PC5-U interface). A layer-2 identifier (ID) (e.g. a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g. the UEs 235 and 236) performing sidelink communications may be configured as follows.

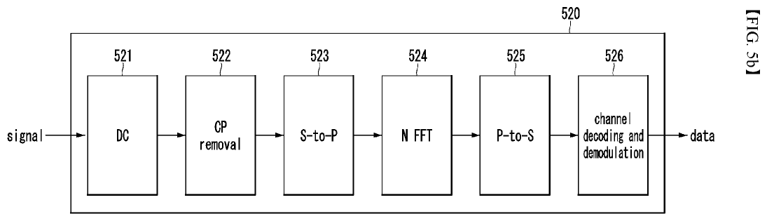

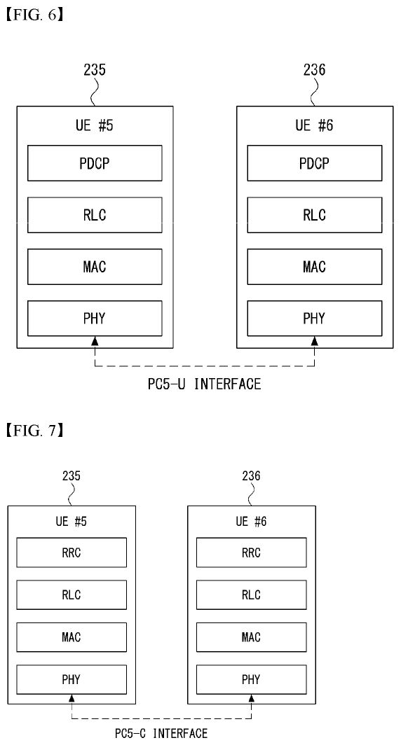

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g. Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g. PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g. UE 235 or 236) by higher layer signaling. The PSCCH may be used for transmitting and receiving sidelink control information (SCI) and may also be configured in the UE (e.g. UE 235 or 236) by higher layer signaling.

The PSDCH may be used for a discovery procedure. For example, a discovery signal may be transmitted over the PSDCH. The PSBCH may be used for transmitting and receiving broadcast information (e.g. system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources scheduled by base station |
| 2 | UE autonomous transmission without scheduling of base |
| | station |
| 3 | Transmission using resources scheduled by base station in |
| | V2X communications |
| 4 | UE autonomous transmission without scheduling of base |
| | station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g. a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g. UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g. UE 235 or 236) within the resource pool configured by the dedicated RRC signaling procedure or the broadcast RRC signaling procedure.

Hereinafter, sidelink communication methods will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a UE #1 (e.g. vehicle #1) is described, a UE #2 (e.g. vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g. SIB12, SIB13, SIB14) and RRC messages including configuration information for sidelink communication (i.e. sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g. SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g. SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g. sidelink data transmission, sidelink-shared channel (SL-SCH) transmission) may be performed based on one SCI (e.g. 1st-stage SCI). When the multi-SCI scheme is used, data transmission may be performed using two SCIs (e.g. 1st-stage SCI and 2nd-stage SCI). The SCI(s) may be transmitted on a PSCCH and/or a PSSCH. When the single-SCI scheme is used, the SCI (e.g. 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, a beam management scheme on a Uu interface, which is a radio interface between a base station and a UE, will be described.

First, signals used for channel state information (CSI) measurement are CSI-RS sets or synchronization signal (SS) blocks.

Second, as a metric for CQI measurement for beams, a Layer 1 Reference Signal Received Power (L1-RSRP) is used.

Third, the maximum number of CSIs that can be reported per terminal is 4 (allowing CSI reporting for 4 beams).

Fourth, reporting information may utilize an L1-RSRP of the strongest beam (i.e. beam with the highest reception power) and difference values between the strongest beam and other three beams.

Fifth, CSI-RS transmission types are defined based on a CSI reporting type and a channel used for CSI reporting as follows.
1) Periodic: periodic+PUCCH
2) Semi-persistent: periodic+PUCCH or semi-persistent+PUSCH
3) Aperiodic: aperiodic (triggered by DCI with a CSI request field)+PUSCH

Sixth, beam adjustment needs to be performed for each of downlink transmission and reception beams. Only beam adjustment on downlink is performed if there is beam reciprocity between uplink and downlink.

The details which have been determined in 3GPP standard meetings regarding NR sidelink (SL) are as follows.

First, signals used for CSI measurement are CSI-RS sets.

Second, as a metric for CQI measurement, an L1-RSRP is used.

Third, up to 2-port CSI-RS can be used.

Fourth, CSI-RS transmission types are defined based on a CSI reporting type and a channel used for CSI reporting as follows.

### 1) Aperiodic: Aperiodic (CSI Reporting Triggered by SCI 2-A or SCI 2-C)+MAC-CE (PSSCH)

All reference signals and physical channels referred to in the present disclosure are SL reference signals and physical channels. Furthermore, in the present disclosure, a first exemplary embodiment will describe slot structures and operation schemes for SL beam management. A second exemplary embodiment will describe CSI-RS transmission patterns for SL beam management. Finally, a third exemplary embodiment will describe configuration and operation of CSI-RS resource set(s) as beam management resources.

### First Exemplary Embodiment: Slot Structures and Operation Schemes for Sidelink Beam Management

In sidelink (SL) communication, beam management is required when communication occurs between a transmitting terminal and a receiving terminal using beamforming. Typically in SL communication, the transmitting terminal may refer to a terminal transmitting data, while the receiving terminal may refer to a terminal receiving data. However, in SL communication, the receiving terminal does not always refer exclusively to a terminal receiving data. The receiving terminal may also transmit a response signal or other information to the transmitting terminal. Accordingly, beam management for a transmission beam of the receiving terminal may also be required to enable the receiving terminal to transmit information to the transmitting terminal.

For SL beam management, one terminal may request beam-related information from at least one other terminal, and transmit CSI-RS(s) to obtain the beam-related information. A terminal that receives the CSI-RS(s) may obtain beam-related information, and report the beam-related information to the terminal that transmitted the CSI-RS(s).

Signaling procedures for beam management between the transmitting and receiving terminals may be implemented in various manners. The present disclosure focuses on methods using CSI-RS. For convenience of description, a terminal transmitting CSI-RS(s) will be referred to as ‘terminal A’, and a terminal receiving the CSI-RS(s) to obtain beam-related information and reporting the obtained beam-related information will be referred to as ‘terminal B’. The above naming for the terminal A and terminal B applies to all exemplary embodiments described in the present disclosure, including not only the first exemplary embodiment but also the second and third exemplary embodiments.

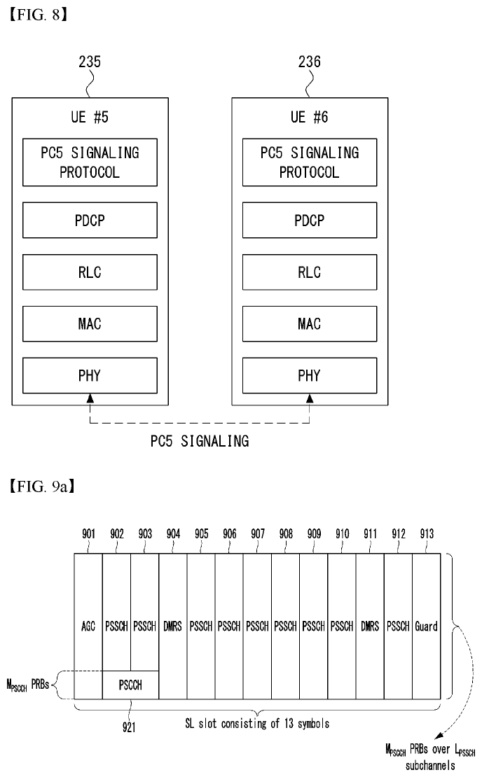

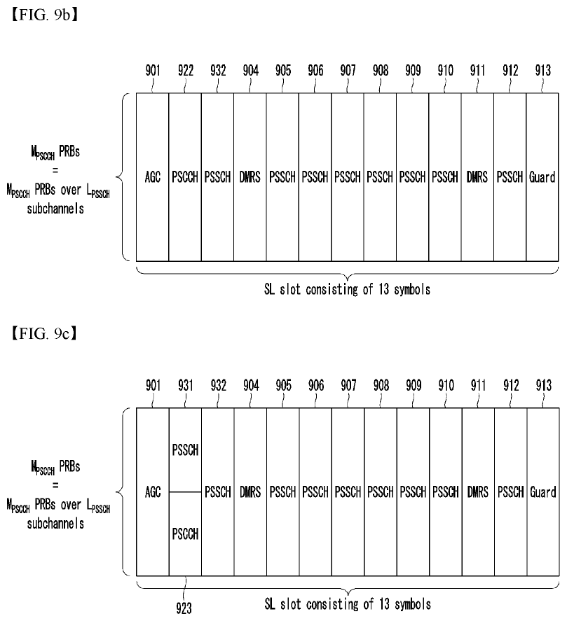

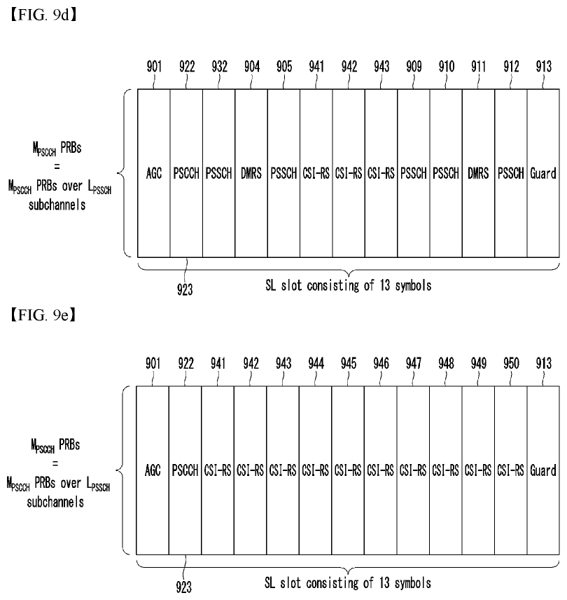

FIG. 9A is a conceptual diagram illustrating a first exemplary embodiment of a PSSCH/PSCCH slot structure with a normal CP.

As shown in FIG. 9A, the first symbol of a SL slot may be allocated as an Auto Gain Control (AGC) symbol 901. A portion of the second and third symbols may be allocated as Physical Sidelink Control Channel (PSCCH) symbols 921. The remaining portion of the second and third symbols may be allocated as Physical Sidelink Shared Channel (PSSCH) symbols 902 and 903. The fourth symbol may be allocated as a demodulation reference signal (DMRS) symbol 904. The fifth to tenth symbols may be allocated as PSSCH symbols 905 to 910. The eleventh symbol may be allocated again as a DMRS symbol 911. The twelfth symbol may be allocated as a PSSCH symbol 912, and the final thirteenth symbol may serve as a guard 913.

As shown in FIG. 9A, the number of PSCCH symbols may be (pre-)configured for each resource pool, and in the frequency domain, the PSCCH symbols 921 may occupy a pre-configurable number MPSCCH of PRBs per resource pool, which may be equal to 10, 12, 15, 20, or 25 PRBs per resource pool. In the example shown in FIG. 9A, the PSCCH symbols 921 are mapped to two symbols, and the PSSCH symbols 902 and 903 may be transmitted in the same symbols where a PSCCH is transmitted.

A CSI-RS for beam management may be transmitted at the PSSCH symbol positions. For instance, a CSI-RS may be transmitted at at least one of the PSSCH symbol positions 902, 903, 905 to 910, and 912.

However, as in FIG. 9A, when the PSCCH symbols 921 are transmitted in the same symbols as certain PSSCH symbols, such as the second and third symbols 902 and 903, the transmission of CSI-RS for beam management may be restricted in a region of the PSSCH symbols. In other words, when resources are allocated for transmitting both the PSCCH symbols 921 and PSSCH symbols in specific symbols, resource allocation for CSI-RS transmission may be restricted in the specific symbols.

Describing cases where CSI-RS transmission is restricted in more detail, it may be assumed that a beam currently used for SL communication is referred to as a first beam, and a beam not currently used for SL communication is referred to as a second beam. If a CSI-RS is transmitted using the second beam, a PSCCH and second-stage SCI, which are control information that need to be transmitted through the first beam, cannot be transmitted simultaneously through the second beam. Therefore, in the PSSCH region where data including the second-stage SCI is transmitted, operations may be configured such that only the first beam is used for transmission. Additionally, a CSI-RS may be transmitted in such PSSCH regions only using the first beam.

As another example, CSI-RS transmission configuration may be allowed in the second and third symbols where the PSCCH symbols 921 are included. If CSI-RS transmission configuration is allowed in the second and third symbols including the PSCCH symbols 921, the operation may be restricted to configuring CSI-RS resources only for CSI measurement purposes rather than for beam management. Such configurations may be pre-configured by CSI-RS resource set configuration information signaled through higher-layer signaling. For instance, in a SL slot structure for which CSI-RS resource set configuration information is configured through higher-layer signaling in a resource pool (RP)-specific or SL-specific manner, the PSSCH symbols 902 and 903 transmitted together with the PSCCH symbols 921 may be configured to measure and report CSI excluding beam-related information. Details regarding such CSI-RS resource set will be further described in the third exemplary embodiment described later.

Furthermore, CSI excluding beam-related information may refer to CSI based on a currently used beam, such as a current channel state, CQI (e.g. RSRP, L1-RSRP, or MCS table index), RI, and PMI. For convenience of description in the present disclosure, CSI for beam management purposes will be referred to as a beam index (BI) and beam quality information (BQI). While BI and BQI are defined in the first exemplary embodiment, they may also be used with the same meaning in the second and third exemplary embodiments.

When the terminal A transmits a CSI-RS for beam management, the terminal B may transmit multiple BIs and BQIs for beams when reporting a CSI report corresponding to the beams. Here, a BQI may be configured as an RSRP or L1-RSRP of a corresponding beam. Alternatively, a BQI may be configured as a difference in RSRP or L1-RSRP values between a reference beam and a measured beam. The reference beam may be a currently used beam or a beam with the best quality among beams for which qualities are measured.

Meanwhile, in the 3GPP Rel. 17 NR, PSCCH symbols may be allocated as 2 symbols or 3 symbols. Accordingly, in the present disclosure, PSCCH symbols may also be either 2 symbols or 3 symbols. Additionally, it is also possible to transmit using a 1-symbol PSCCH structure for beam management in FR2. The present disclosure does not impose specific constraints on the number of PSCCH symbols.

FIG. 9B is a conceptual diagram illustrating a second exemplary embodiment of a SL slot structure where PSCCH is allocated to a single symbol.

As shown in FIG. 9B, the first symbol of a SL slot may be allocated as an AGC symbol 901, similar to FIG. 9A. The second symbol of the SL slot may be allocated as a PSCCH symbol 922, and the third symbol may be allocated as a PSSCH symbol 932. In addition, the fourth symbol of the SL slot may be allocated as a DMRS symbol 904, as in FIG. 9A. The fifth to tenth symbols may include PSSCH symbols 905 to 910, the eleventh symbol may be allocated again as a DMRS symbol 911, the twelfth symbol may be allocated as a PSSCH symbol 912, and the final thirteenth symbol may serve as a guard 913.

The example in FIG. 9B corresponds to a case where the number of subchannels and the number of PRBs allocated to the PSCCH symbol 922 and PSSCH symbols 932, 905 to 910, and 912 are configured identically. This is an example of a structure where the PSCCH symbol 922 is mapped to the second symbol in the configured SL slot. In the SL slot structure shown in FIG. 9B, a CSI-RS may be transmitted in at least one of the symbols where a PSSCH is allocated. When a CSI-RS for beam management is transmitted in the SL slot configuration illustrated in FIG. 9B, the terminal A may transmit second-stage SCI in the PSSCH symbol 932 of the third symbol. Additionally, the terminal A may transmit data including the second-stage SCI in the PSSCH symbol 932 of the third symbol. To enable the transmission of data including second-stage SCI in the PSSCH symbol 932 in the third symbol, CSI-RS transmission may be restricted in the PSSCH symbol 932 of the third symbol.

In the case of the SL slot structure shown in FIG. 9B, if a resource for transmitting first-stage SCI, specifically the PSCCH symbol 922, is insufficient with a single symbol, the structure may be extended to a 2-symbol PSCCH structure. In other words, while the SL slot structure in FIG. 9B illustrates only the 1-symbol PSCCH 922, it may be extended to a 2-symbol PSCCH structure based on technical specifications.

Meanwhile, since the SL slot in FIG. 9B is used for beam management, it may be configured to transmit only the first-stage SCI in the symbol allocated for the PSCCH 922 without transmitting the second-stage SCI.

FIG. 9C is a conceptual diagram illustrating a third exemplary embodiment of a SL slot structure where both PSCCH and PSSCH are mapped to the second symbol.

As shown in FIG. 9C, the first symbol of a SL slot may be allocated as the AGC symbol 901, similarly to FIG. 9A. The second symbol of the SL slot may include both a PSCCH symbol 923 and a symbol PSSCH 931. Starting from the third symbol, the structure may be identical to that of FIG. 9A. Specifically, the third symbol may be allocated as the PSSCH symbol 932, the fourth symbol may be allocated as the DMRS symbol 904, the fifth to tenth symbols may be allocated as the PSSCH symbols 905 to 910, the eleventh symbol may be allocated as the DMRS symbol 911, the twelfth symbol may be allocated as the PSSCH symbol 912, and the final thirteenth symbol may serve as the guard 913.

In the SL slot structure shown in FIG. 9C, when a CSI-RS for beam management is transmitted, the PSSCH symbol 931 in the second symbol may be configured to allow only transmission of data including second-stage SCI. In other words, CSI-RS transmission for beam management may be restricted in the PSSCH symbol 931 in the second symbol. Meanwhile, CSI-RS for beam management may be transmitted in at least one of the other symbols where a PSSCH can be transmitted.

FIG. 9D is a conceptual diagram illustrating a fourth exemplary embodiment where positions of symbols for transmitting CSI-RS for beam management are determined.

As shown in FIG. 9D, the first symbol of a SL slot may be allocated as the AGC symbol 901, similarly to FIG. 9A. The second symbol of the SL slot may be allocated as the PSCCH symbol 922 in a single symbol, as in FIG. 9B, and the third symbol of the SL slot may be allocated as the PSSCH symbol 932, also as in FIG. 9B. The fourth symbol may be allocated as the DMRS symbol 904, similarly to FIG. 9A, and the fifth symbol may be allocated as the PSSCH symbol 905. Additionally, the sixth to eighth symbols are illustrated as including CSI-RSs 941 to 943 for beam management. The ninth and tenth symbols may be allocated as the PSSCH symbols 909 and 910, as in FIG. 9A, the eleventh symbol may be allocated as the DMRS symbol 911, the twelfth symbol may be allocated as the PSSCH symbol 912, and the final thirteenth symbol may serve as the guard 913.

As shown in FIG. 9D, resources for transmitting CSI-RS, specifically the symbols for CSI-RS transmission, may be pre-configured and operated accordingly. In the example of FIG. 9D, a PSCCH for first-stage SCI transmission and a PSSCH for second-stage SCI transmission may be transmitted in separate symbols. In a variation, as described in FIG. 9C, a PSCCH for first-stage SCI transmission and a PSSCH for second-stage SCI transmission may be configured to be transmitted simultaneously in a single symbol. In another variation, a PSCCH for first-stage SCI transmission and a PSSCH for second-stage SCI transmission may each be transmitted over one or more symbols.

FIG. 9E is a conceptual diagram illustrating a fifth exemplary embodiment where positions of symbols for transmitting CSI-RS for beam management are determined.

As shown in FIG. 9E, the first symbol of a SL slot may be allocated as the AGC symbol 901, as in FIG. 9A. The second symbol of the SL slot may be allocated as a PSCCH symbol. Subsequently, from the third symbol 941 to the twelfth symbol 950, CSI-RSs 941 to 950 for beam management may be allocated. The final thirteenth symbol may serve as the guard 913.

The configuration of FIG. 9E provides an advantage over FIG. 9D by enabling CSI-RS transmission in more symbols, allowing the receiving terminal to more easily detect the CSI-RS for beam management.

In the case of FIG. 9E, only first-stage SCI may be used without second-stage SCI. When only first-stage SCI is used without second-stage SCI, the first-stage SCI may include information implicitly indicating or explicitly indicating that second-stage SCI is not present.

In FIG. 9D and FIG. 9E, the first-stage SCI may include time and frequency resource information for configuring CSI-RS transmission resources. Additionally, in FIG. 9D and FIG. 9E, the first-stage SCI may implicitly or explicitly include indication information regarding specific CSI-RS configuration information within CSI-RS resource set configuration configured by higher-layer signaling. When the first-stage SCI includes an indication of specific CSI-RS configuration information within the CSI-RS resource set configuration configured by higher-layer signaling, as described above, the first-stage SCI may be defined and used in a format that includes time and frequency resource information for configuring CSI-RS transmission resources. In other words, a new standalone SCI format may be defined and used according to the present disclosure.

In FIGS. 9A to 9E described above, various structures of SL slots with 13 symbols have been described. However, the present disclosure is not limited to the structures in FIGS. 9A to 9E, and the number of symbols and/or the slot structure may be applied in forms that are modified or extended from the examples illustrated in FIGS. 9A to 9E.

In particular, examples where the PSSCH resource regions are exclusively used as resource regions for beam management, as shown in FIGS. 9D and 9E, may be included.

In the examples of FIGS. 9A and 9C described earlier, it is assumed that CSI-RS is transmitted in the symbols allocated to PSSCH. However, independently of the regions, beam management resources (i.e. CSI-RS transmission resources) may be configured and operated. For example, in the case of FIG. 9D, when configuring the CSI-RS resources, resources for obtaining CSI excluding beam-related information and reporting the CSI may use PSSCH resources (e.g. 932, 905, 909-910), and according to the present disclosure, resources for obtaining and reporting beam-related information for beam management may use the regions of CSI-RS resources 941 to 943. The configuration of this operation scheme may be pre-configured using CSI-RS resource set configuration information configured by higher-layer signaling.

The SL slot structures have been described in FIGS. 9A to 9E above. In particular, the present disclosure has described an example where a single SL slot consists of 13 symbols. However, the present disclosure may also be applied even if a single SL slot does not consist of exactly 13 symbols. For instance, the present disclosure may be applied based on the description above, to a SL slot consisting of more than 13 symbols or fewer than 13 symbols.

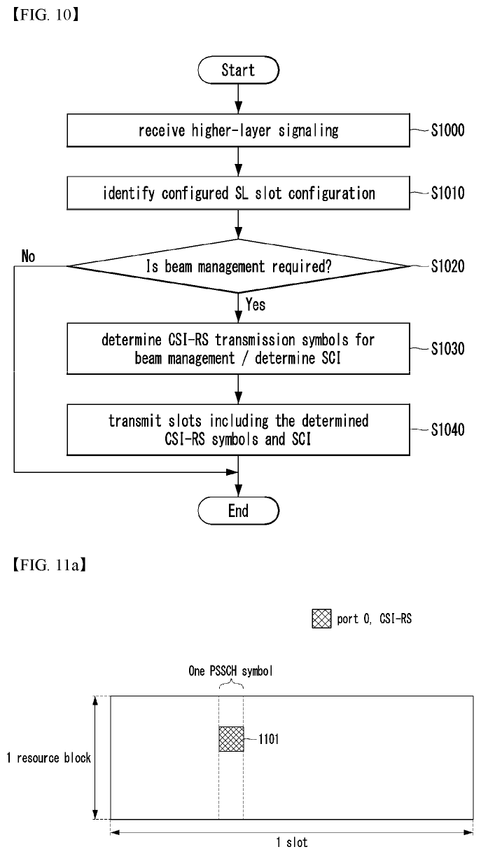

FIG. 10 is a flowchart illustrating a case where a SL slot for beam management is configured and used for communication.

Operations in FIG. 10 may be performed by all terminals performing SL communication. The terminal may include the entire configuration described earlier in FIGS. 3 to 8 or at least a portion thereof. Additionally, SL communication may be performed under the control of the base station 210 as shown in FIG. 2, or may be performed based on the terminal's own sensing. In the following description with reference to FIG. 10, it is assumed that higher-layer signaling is received from the base station 210, while other operations are assumed to be performed by the terminal.

As shown in FIG. 10, in step S1000, the terminal may receive higher-layer signaling. The higher-layer signaling may include information for configuring at least the SL slot structure, as described in FIGS. 9A to 9E. Additionally, the higher-layer signaling may implicitly or explicitly indicate which PSSCH is used to transmit CSI-RS transmission symbols for beam management if the CSI-RS transmission symbols are not specified, as in FIGS. 9A to 9C. As another example, even if the CSI-RS transmission symbols for beam management are not specified, as in FIGS. 9A to 9C, the higher-layer signaling may not indicate the positions where the CSI-RS transmission symbols for beam management need to be transmitted.

In step S1010, the terminal may identify the SL slot configuration based on the higher-layer signaling. In other words, the terminal may identify the SL slot configuration described in FIGS. 9A to 9E. Alternatively, if a variation of the SL slot described in FIGS. 9A to 9E is configured through higher-layer signaling in step S1000, the terminal may identify the variation of the SL slot based on the higher-layer signaling.

In step S1020, the terminal may determine whether beam management is required. Beam management may be needed in various scenarios, such as when SL communication is required, when a beam used for SL communication needs to be switched, or when a priority of data changes. The present disclosure does not impose specific restrictions on the various scenarios requiring beam management.

If beam management is required, the terminal may proceed to step S1030, and if beam management is not required, the routine of FIG. 10 may be terminated.

In step S1030, the terminal may determine symbols for transmitting CSI-RS for beam management and determine SCI and symbols where the SCI is to be transmitted. As described in FIGS. 9A to 9E, the SCI may include first-stage SCI and/or second-stage SCI.

The determination of the symbols for transmitting the CSI-RS for beam management in step S1030 may be based on the higher-layer signaling received in step S1000 or may be determined autonomously by the terminal. If the terminal autonomously determines the symbols for transmitting the CSI-RS for beam management, information related to positions of the CSI-RS symbols may be indicated through the SCI. Therefore, when the terminal autonomously determines the positions of the symbols for transmitting the CSI-RS for beam management, the SCI may include information on the positions of the CSI-RS symbols.

In step S1040, the terminal may transmit a slot that includes the determined CSI-RS symbols and SCI. In other words, the terminal may transmit a SL slot in the form illustrated in FIGS. 9A to 9E or a variation of the SL slot.

The terminal described above with reference to FIG. 10 may correspond to the previously defined terminal A, and the terminal receiving the SL slot may correspond to the terminal B.

Meanwhile, the above-described information according to the first exemplary embodiment may be transmitted in advance by the base station to the terminal A and terminal B via higher-layer signaling as ‘slot configuration information’ for SL communication. In other words, the slot configuration information may include information on the positions of PSSCH/PSCCH/CSI-RS symbols, as shown in FIGS. 9A to 9E. The slot configuration information may also include information on a variation of symbol positions derived from FIGS. 9A to 9E.

Meanwhile, the first exemplary embodiment may be applied together with the second exemplary embodiment described below or applied independently. Additionally, the first exemplary embodiment may also be applied in conjunction with the third exemplary embodiment described below.

### Second Exemplary Embodiment: CSI-RS Transmission Patterns for Sidelink Beam Management

Hereinafter, CSI-RS transmission patterns for sidelink beam management will be described. It should be noted that the first exemplary embodiment described above and the second exemplary embodiment described below may be performed together.

A CSI-RS transmission pattern may be configured according to the number of ports and a CSI-RS multiplexing scheme (e.g. code division multiplexing (CDM), time division multiplexing (TDM), and frequency division multiplexing (FDM)). If the maximum number of CSI-RS transmission ports is limited to 2 ports in SL, the following CSI-RS transmission patterns are possible.

For convenience of description, it is assumed that CSI-RS is transmitted in PSSCH symbols. Additionally, it is assumed that in symbols for PSSCH transmission, for a 1-port CSI-RS per resource block (RB), one resource element (RE) is used for transmission, and for a 2-port CSI-RS, two REs are used for transmission. In other words, a CSI-RS density of 1 is assumed.

The concept of CSI-RS density may be described in more detail through examples. For instance, in the case of 2-port CSI-RS transmission, if two REs are used within one RB in one symbol to transmit the CSI-RS, the density is 1. In another example, in the case of 2-port CSI-RS transmission, if four REs are used within one RB in one symbol to transmit the CSI-RS, the density is 2. In yet another example, in the case of 2-port CSI-RS transmission, if two REs are used in one RB out of every two RBs to transmit the CSI-RS, the density is ½.

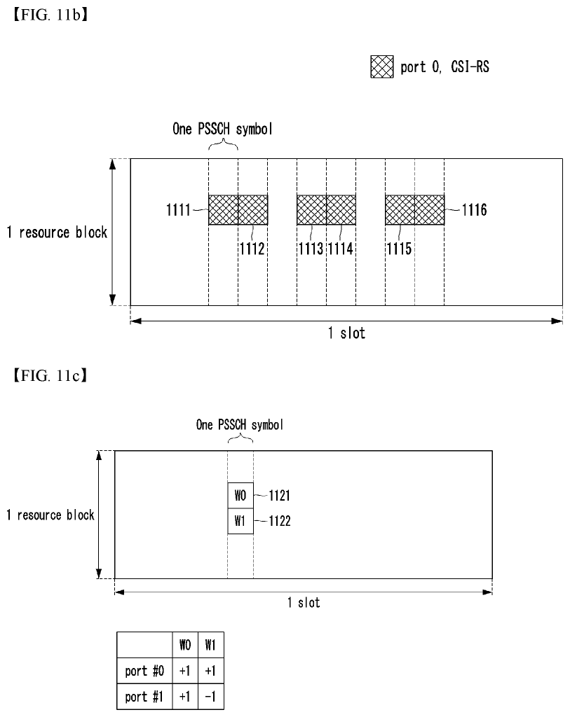

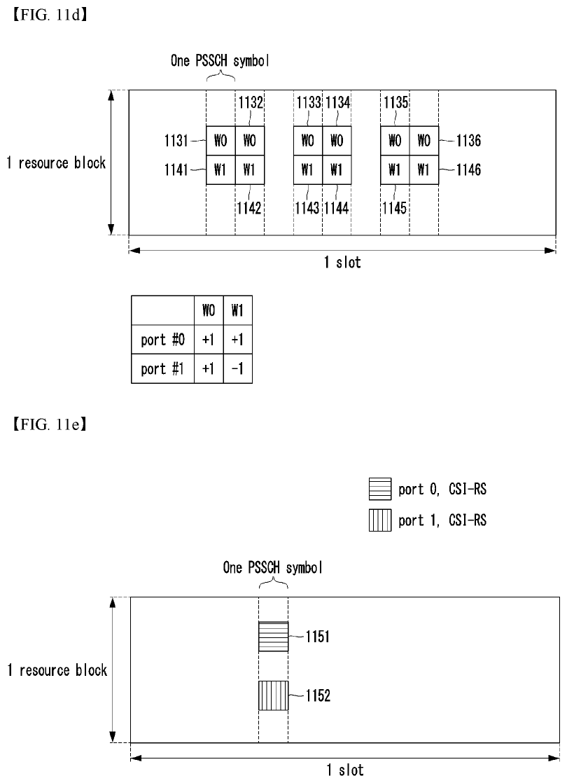

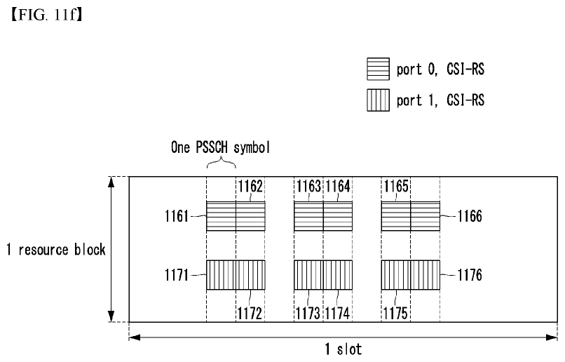

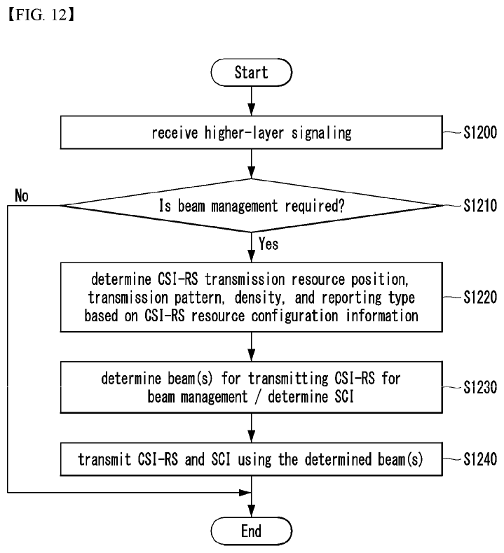

In the present disclosure described below, for convenience of description, CSI-RS transmission patterns will be described based on a density of 1. However, the present disclosure is not limited to a density of 1 and may also be applied in cases with a density of 2 or ½. Additionally, while frequency resources of a single SL slot may consist of multiple RBs, for convenience of description, CSI-RS transmission patterns will be illustrated and described based on a single RB among the multiple RBs constituting the SL slot. The second exemplary embodiments described below in FIGS. 11A to 11F assume that a single SL slot consists of one resource block. However, a single slot may be composed of multiple resource blocks. However, for convenience of description, the examples in the drawings and their descriptions assume that a single slot consists of one resource block. Furthermore, CSI-RS transmission patterns described below may be directly applied or modified for CSI-RS used for CSI measurement and reporting other than beam-related information.

FIG. 11A is a conceptual diagram illustrating a first exemplary embodiment where CSI-RS is transmitted through a 1-port in a single slot.

As shown FIG. 11A, an example is illustrated where a single slot consists of one resource block. In the example of FIG. 11A, it is assumed that CSI-RS for beam management is transmitted using one of symbols among multiple symbols in which a PSSCH is transmitted. Specifically, the single SL slot may include one or multiple PSSCH symbols, as described in the first exemplary embodiment. In FIG. 11A, among the multiple symbols constituting the single SL slot, one PSSCH symbol may be selected, and a specific RE 1101 within the selected PSSCH symbol may be used to transmit the CSI-RS for beam management according to the present disclosure.

Additionally, the case shown in FIG. 11A involves using a single port. When a single port is used, a port indicated by a port number expressed as ‘port 0’ or ‘port #0’ may be used. Therefore, FIG. 11A corresponds to a case where the CSI-RS is transmitted through the port 0 using one RE per RB in a single PSSCH symbol.

FIG. 11B is a conceptual diagram illustrating a second exemplary embodiment where CSI-RS is transmitted through a 1-port in a single slot.

As shown in FIG. 11B, a single slot may consist of multiple symbols. In the example of FIG. 11B, CSI-RSs for beam management may be transmitted using multiple PSSCH symbols among the multiple symbols. Specifically, the single SL slot may include one or multiple PSSCH symbols, as described in the first exemplary embodiment. In FIG. 11B, among the multiple symbols constituting the single SL slot, multiple PSSCH symbols may be selected in units of two consecutive PSSCH symbols. Then, the CSI-RSs for beam management according to the present disclosure may be transmitted using the REs 1111 to 1116 in the same position within the selected symbols.

More specifically, the RE 1111 where the first CSI-RS is transmitted and the RE 1112 where the second CSI-RS is transmitted may be in consecutive symbols. Similarly, the RE 1113 where the third CSI-RS is transmitted and the RE 1114 where the fourth CSI-RS is transmitted may also be in consecutive symbols. Additionally, the RE 1115 where the fifth CSI-RS is transmitted and the RE 1116 where the sixth CSI-RS is transmitted may also be in consecutive symbols.

However, the RE 1112 where the second CSI-RS is transmitted and the RE 1113 where the third CSI-RS is transmitted may not be in consecutive symbols, and the RE 1114 where the fourth CSI-RS is transmitted and the RE 1115 where the fifth CSI-RS is transmitted may not be in consecutive symbols.

Thus, the example in FIG. 11B may correspond to a case where three groups, each comprising two consecutive symbols, are selected for CSI-RS transmission. Moreover, as described earlier, FIG. 11B assumes the use of a single port. When a single port is used, the port number may be represented as ‘port 0’ or ‘port #0’. Therefore, FIG. 11B may correspond to a case where three groups of consecutive two-symbol units are selected from the PSSCH symbols in a single slot, and CSI-RS is transmitted through the port 0 at the same RE position within the selected groups.

The case where beam management is performed by transmitting CSI-RS as in FIG. 11B will be described. The terminal A, which transmits beams, may transmit CSI-RSs transmitted in the respective symbols through different beams. In another example, the terminal A may transmit all CSI-RSs in the respective symbols using the same beam. In yet another example, the terminal A may transmit some of the symbols within the three groups of consecutive two-symbol units through a first beam, and transmit the remaining symbols through a second beam. In cases where three or more beams are used, the symbols to be transmitted through the beams may be divided into three groups, and CSI-RSs may be transmitted through the separated beams.

The number of consecutive symbols for CSI-RS transmission and the number of groups in FIG. 11B may be configured and operated in various manners.

Meanwhile, in FIGS. 11A and 11B, the positions of the REs, namely the positions of subcarriers within a single RB, have been illustrated as being the same. In other words, the CSI-RSs may be transmitted at fixed positions. The positions of the subcarriers within a single RB where CSI-RS is transmitted may be configured in an RP-specific or SL-specific manner.

The case in FIG. 11B where the terminal A transmits CSI-RSs through different beams using a single port (i.e. port 0) will be described.

The terminal A may transmit CSI-RSs to the terminal B through multiple beams for the purpose of transmission beam switching or transmission beam management. The terminal B, which receives the multiple beams transmitted by the terminal A, may measure the CSI-RS transmitted through each of the received beams. Based on the measurement results of the CSI-RS for each beam, the terminal B may generate beam information to report to the terminal A. The terminal B may then report the beam information corresponding to each of the multiple beams to the terminal A.

If the terminal A transmits a 1-port CSI-RS through a specific beam in each symbol, the beam used by the terminal A to transmit the CSI-RS may serve as a reference for the terminal B to switch its reception beam. The terminal B, which receives the beam used to transmit the CSI-RS from the terminal A, may measure the CSI-RS transmitted through the beam, and generate beam information. Based on the generated beam information, the terminal B may switch its reception beam.

FIG. 11C is a conceptual diagram illustrating a third exemplary embodiment where CSI-RS is transmitted through 2-ports in a single slot.

As shown in FIG. 11C, a single slot may consist of multiple symbols. The example in FIG. 11C illustrates a case where CSI-RS for beam management is transmitted using one of symbols in which a PSSCH is transmitted among the multiple symbols. Specifically, within a single resource block (RB), the single SL slot may include one or multiple PSSCH symbols, as described in the first exemplary embodiment. In FIG. 11C, one PSSCH symbol may be selected from among the multiple symbols constituting the single SL slot, and specific REs 1121 and 1122 within the selected PSSCH symbol may be used to transmit CSI-RS for beam management according to the present disclosure.

Unlike FIG. 11A, the case in FIG. 11C involves using two ports. When two ports are used, the port numbers may be represented as ‘port 0’ or ‘port #0’ for the first port and ‘port 1’ or ‘port #1’ for the second port. Therefore, FIG. 11C may correspond to a case where two REs per RB are used in a single PSSCH symbol to transmit CSI-RS through the port #0 and port #1.

FIG. 1C illustrates an example of multiplexing a 2-port CSI-RS using a CDM scheme. In this case, the CSI-RSs transmitted from the respective ports of the terminal A may be transmitted using either different beams or the same beam. Even if the terminal A transmits the 2-port CSI-RS in the CDM scheme through multiple different beams, the terminal B may receive the CSI-RS for beam management through a single fixed beam. In other words, the terminal B may receive multiple beams through a single fixed beam. The terminal B may measure the CSI-RS included in each of the multiple beams. Based on results of the measurements of the CSI-RS included in each beam, the terminal B may generate beam information corresponding to each beam. The terminal B may then report the beam information generated for each beam to the terminal A.

When transmitting the CSI-RSs through two or more ports, if the CSI-RSs are configured to be transmitted using the CDM scheme, the terminal B may recognize that each CSI-RS transmitted through each port of the terminal A is transmitted through a different beam. That is, when the terminal A transmits the CSI-RSs through two or more ports, the terminal A may indicate to the terminal B that the CSI-RSs transmitted through different ports are transmitted through different beams based on the information configured for transmission using the CDM scheme. This indication may be implicit.

For example, in sidelink communication, the terminal A may transmit a first transmission beam to the terminal B through the port #0 and transmit a second transmission beam, which is different from the first transmission beam, through the port #1. When the terminal A transmits the CSI-RSs in the CDM scheme through two ports in the above-described manner, the terminal B may receive the first transmission beam and the second transmission beam using a single first reception beam. In this case, the terminal B may be communicating with the first transmission beam through the first reception beam. In another example, the terminal B may be communicating with the second transmission beam through the first reception beam. In other words, the terminal B may be in a state of communicating with the terminal A using either the first transmission beam or the second transmission beam. In this case, the terminal B may measure a quality of the first transmission beam received through the first reception beam and a quality of the second transmission beam received through the first reception beam. Based on the measurement results, the terminal B may determine which of the first transmission beam or the second transmission beam is more suitable for communication. Accordingly, the terminal B may report the measurement results to the terminal A using BI and BQI. In this case, the reported information may be configured as a difference in (L1-)RSRPs between the first transmission beam transmitted through the port #0 and the second transmission beam transmitted through the port #1.

FIG. 11D is a conceptual diagram illustrating a fourth exemplary embodiment where CSI-RS is transmitted through 2-ports within a single slot.

As shown in FIG. 11D, a single SL slot may consist of multiple symbols, and a CSI-RS for beam management may be transmitted using multiple symbols in which a PSSCH is transmitted among the multiple symbols constituting the single SL slot. Specifically, the CSI-RS for beam management according to the present disclosure may be transmitted using specific REs 1131 and 1141 within one of the multiple symbols in the single SL slot.

In FIG. 11D, multiple symbols may be selected in units of two consecutive PSSCH symbols from among the multiple symbols constituting the single SL slot. In addition, the CSI-RS may be transmitted through two consecutive resource blocks (e.g. 1131 and 1141) within the selected one symbol. The example of the first symbol will be described. In the first symbol where the CSI-RS is transmitted, the 2-port CSI-RS may be transmitted through two resource blocks (e.g. 1131 and 1141). Additionally, the CSI-RS transmitted through the respective ports may be multiplexed using different orthogonal codes (W0, W1) within the same symbol. Similarly, in the second symbol (e.g. resource blocks 1132 and 1142) where the CSI-RS is transmitted, the 2-port CSI-RS may also be transmitted in the CDM scheme for the respective ports.

FIG. 11D also illustrates a case where three groups are selected in units of two consecutive symbols. In the above description, the transmission for the first group among the three groups of two-symbol units has been described. For the remaining two groups, the CSI-RS may be transmitted in the same manner.

Therefore, the example in FIG. 11D aligns with the case described in FIG. 11B, where three groups are selected in units of two consecutive symbols for CSI-RS transmission.

In the case of FIG. 11D where the 2-port CSI-RS is transmitted in the CDM scheme, the transmission may be performed in consecutive or non-consecutive PSSCH symbols, depending on the configured CSI-RS transmission resources. When beam management is performed using the CSI-RS, the CSI-RS transmitted by the terminal A in each symbol may be transmitted using a different beam. Alternatively, it may be transmitted using the same beam. Another example may be that some of the CSI-RSs may be transmitted using the same beam, while others may be transmitted using different beams. When transmitting the CSI-RSs through two ports in FIGS. 11C and 11D, a position of subcarriers for each CSI-RS transmission in one RB may be configured as a fixed position in an RP-specific or SL-specific manner.

Meanwhile, in FIG. 11D, when transmitting the respective CSI-RSs through two ports, the terminal B may switch a reception beam for each symbol unit to measure beam information. Therefore, the above-described measurement may be used for beam management purposes, such as switching the transmission beam of the terminal A or the reception beam of the terminal B.

FIG. 11E is a conceptual diagram illustrating a fifth exemplary embodiment where a CSI-RS is transmitted through 2 ports in a FDM scheme within a single slot.

As shown in FIG. 11E, a single SL slot may include multiple symbols. Among the multiple symbols constituting the single SL slot, CSI-RS may be transmitted at different RE positions 1151 and 1152 through different ports (port 0 and port 1), respectively. In this case, the symbols where the CSI-RS is transmitted may be PSSCH symbols, as described earlier. Therefore, FIG. 11E may correspond to a case where the CSI-RS is transmitted in an FDM scheme through two different REs within one symbol, in a single SL slot consisting of one resource block. In other words, FIG. 11E may represent a scheme where the CSI-RSs are multiplexed through two ports in the FDM scheme.

In this case, the CSI-RSs transmitted by the terminal A through the respective ports may be transmitted using either different beams or the same beam. When the CSI-RSs are transmitted for beam management purposes, the terminal B may receive the CSI-RSs using a single fixed beam in the corresponding symbol. Therefore, if the terminal A transmits the CSI-RSs through two ports in the FDM scheme, each CSI-RS may be transmitted using a different beam. The terminal B may measure beam information for each of the beams transmitting the CSI-RSs using a single reception beam. The terminal B may then report the measured beam information to the terminal A.

When transmitting the CSI-RSs using two or more ports, if the transmission is configured to use the FDM scheme, the terminal B may recognize that the CSI-RSs transmitted through the respective ports are transmitted using different beams. In other words, when the CSI-RSs are transmitted using two or more ports, the FDM transmission configuration may implicitly indicate to the terminal B that the CSI-RSs are transmitted using different beams.

For example, in sidelink communication, the terminal A may transmit the CSI-RS through the port 0 by using a beam used for SL communication, and transmit the CSI-RS through the port 1 by using a different beam, which is not used for SL communication, in the FDM scheme. In this case, the terminal B may receive both a first beam currently used for SL communication and a second beam, which is not used for SL communication, using the same reception beam and measure the beam information. When the CSI-RS is transmitted through abeam other than the one used for SL communication, as described above, the terminal B may determine whether there is a better beam of the terminal A compared to the currently used first beam. The terminal B may then report a result of its determination to the terminal A using BI and BQI. In this case, the terminal B may configure the reported information by transmitting a difference in (L1-)RSRPs between the beam transmitted through the port 0 and the beam transmitted through the port 1.

FIG. 11F is a conceptual diagram illustrating a sixth exemplary embodiment where CSI-RS is transmitted through 2-ports in a FDM scheme within a single slot.

As shown in FIG. 11F, a single SL slot may include multiple symbols. Among the multiple symbols constituting the single SL slot, CSI-RS may be transmitted at different RE positions 1161 and 1171 through different ports (e.g. port 0 and port 1), respectively. In this case, the symbols where the CSI-RS is transmitted may be PSSCH symbols, as described earlier. Therefore, FIG. 11F may correspond to a case where the CSI-RS is transmitted through two different REs in the FDM scheme within a single symbol in a slot consisting of one resource block.

In comparison to the exemplary embodiment in FIG. 11E, the exemplary embodiment in FIG. 11F illustrates a case where the CSI-RSs are transmitted in three groups in units of two consecutive symbols. In other words, FIG. 11F may be considered an extended example of FIG. 11E, where the CSI-RSs are multiplexed using FDM through two ports.

In FIG. 11F, multiple groups may be selected in units of two consecutive PSSCH symbols among the symbols constituting the single SL slot. Within the selected symbols, the CSI-RS may be transmitted at specific RE positions 1161 to 1166 through the port 0. Additionally, the CSI-RS may be transmitted at other RE positions 1171 to 1176 within the selected symbols through the port 1.

More specifically, within the SL slot, the RE 1161 where a first CSI-RS is transmitted through the port 0 and the RE 1162 where a second CSI-RS is transmitted may correspond to consecutive symbols. Similarly, the RE 1163 where a third CSI-RS is transmitted through the port 0 and the RE 1164 where a fourth CSI-RS is transmitted may also correspond to consecutive symbols. Furthermore, the RE 1165 where a fifth CSI-RS is transmitted through the port 0 and the RE 1166 where a sixth CSI-RS is transmitted may correspond to consecutive symbols.

In the same manner, the RE 1171 where the first CSI-RS is transmitted through the port 1 and the RE 1172 where the second CSI-RS is transmitted may correspond to consecutive symbols. Similarly, the RE 1173 where the third CSI-RS is transmitted through the port 1 and the RE 1174 where the fourth CSI-RS is transmitted may correspond to consecutive symbols. Furthermore, the RE 1175 where the fifth CSI-RS is transmitted through the port 1 and the RE 1176 where the sixth CSI-RS is transmitted may correspond to consecutive symbols.

In this case, the RE 1161 where the first CSI-RS is transmitted through the port 0 and the RE 1171 where the first CSI-RS is transmitted through the port 1 may be transmitted as being FDMed. In the same manner, the RE 1162 where the second CSI-RS is transmitted through the port 0 and the RE 1172 where the second CSI-RS is transmitted through the port 1 may also be transmitted as being FDMed. This method may be equally applied to each group.

In the case of transmitting CSI-RSs using FDM with two ports, as shown in FIG. 11E, transmission may occur in either consecutive or non-consecutive PSSCH symbols, depending on a CSI-RS transmission resource configuration. When performing beam management using the CSI-RSs as described above, the CSI-RSs transmitted by the terminal A in the respective symbols may be transmitted using different beams. Alternatively, when performing beam management using the CSI-RSs, the CSI-RSs transmitted by the terminal A in the respective symbols may be transmitted using the same beam. As another example, when performing beam management using the CSI-RS, some of the CSIs-RS transmitted by the terminal A in the respective symbols may be transmitted using the same beam and others of the CSI-RSs may be transmitted using different beams. When transmitting the CSI-RSs through two ports in FIGS. 11E and 11F, positions of subcarriers for CSI-RS transmission within one RB may be configured as fixed positions in an RP-specific or SL-specific manner.

As illustrated in FIG. 11F, since the terminal A transmits the CSI-RS through two ports, the terminal B may change a reception beam for each symbol unit to measure beam information. Therefore, this measurement may be used for beam management, such as changing the transmission beam of the terminal A or the reception beam of the terminal B.

FIG. 12 is a flowchart illustrating determination of a CSI-RS transmission pattern for beam management in SL communication according to the second exemplary embodiment of the present disclosure.

Operations in FIG. 12 may be performed by all terminals participating in SL communication. The terminal may include the entirety or at least a portion of the configuration described in FIGS. 3 to 8. Additionally, SL communication may be performed under the control of the base station 210 as shown in FIG. 2 or based on the terminal's own sensing. In the following description referring to FIG. 12, it is assumed that higher-layer signaling is received from the base station 210, while other operations are assumed to be performed by the terminal.

As shown in FIG. 12, in step S1200, the terminal may receive higher-layer signaling. The higher-layer signaling may include configuration information for transmitting CSI-RS in at least one of the schemes described in FIGS. 11A to 11F.

In step S1210, the terminal may determine whether beam management is required. Beam management may be required in various cases, such as when SL communication is required, when a beam used for SL communication needs to be switched, or when a priority of data changes. The present disclosure does not impose specific limitations on the various cases requiring beam management.

If beam management is required, the terminal may proceed to step S1220. If beam management is not required, the routine in FIG. 12 may be terminated.

In step S1220, the terminal may determine CSI-RS transmission resource positions, transmission pattern, density, and reporting type based on the CSI-RS resource configuration information. The reporting types will be described in greater detail in the third exemplary embodiment below.

In step S1230, the terminal may determine beam(s) for transmitting CSI-RS for beam management, beam(s) for transmitting SL data, and SCI for transmitting the SL data and/or CSI-RS. In this case, the beam(s) for transmitting the CSI-RS, as well as a density and pattern of the CSI-RS, may be determined based on the information determined in step S1220.

In step S1240, the terminal may transmit the CSI-RS and SCI using the determined beam(s). In this case, the determined beam(s) may be a single beam or multiple beams. The number of beam(s) and the CSI-RS transmitted through the beam(s) may be determined based on the descriptions provided in FIGS. 11A to 11F.

Meanwhile, FIGS. 11A to 11F, as described above, illustrate methods for transmitting CSI-RS for beam management. In other words, as pattern information for CSI-RS used for beam management, one of the TDM, FDM, or CDM scheme may be applied. Additionally, the pattern information for CSI-RS used for beam management may include the number of ports through which the CSI-RS for beam management is transmitted, as described above. Furthermore, the pattern information for CSI-RS may include density information for the CSI-RS used for beam management, as described above.

Meanwhile, the second exemplary embodiment may be applied together with the first exemplary embodiment described earlier or independently. Additionally, the second exemplary embodiment may also be applied together with the third exemplary embodiment described below.

### Third Exemplary Embodiment: Configuration and Operation of CSI-RS Resource Sets for Beam Management Support

To use the slot structure and operational schemes of the first exemplary embodiment described in FIGS. 9A to 9E and FIG. 10, as well as the CSI-RS transmission patterns for SL beam management described in the second exemplary embodiment in FIGS. 11A to 11F and FIG. 12, the CSI-RS resource set configuration information may be configured and operated as shown in Table 3 below.

TABLE 3

| | | CSI-RS | CSI-RS | |
|---|---|---|---|---|
| Configured | | transmission | transmission | CSI |
| CSI-RS | | resource | pattern and | reporting |
| resource set | identifier | position | density | type |
| CSI-RS RS #2 | 00 | time-frequency | (2-port | CQI, RI |
| | | resource #1 | CDM, 1) | |
| CSI-RS RS #4 | 01 | time-frequency | (2-port | BI, BQI |
| | | resource #2 | FDM, 2) | |
| CSI-RS RS #5 | 10 | time-frequency | (1-port, 1) | N/A or BQI |
| | | resource #3 | | |
| CSI-RS RS #7 | 11 | time-frequency | (1-port, 1) | CQI, RI, BI, |
| | | resource #4 | | BQI |

The example in Table 3 represents one possible configuration of the CSI-RS resource set (CSI-RS RS) information received by the terminal A from the base station through higher-layer signaling. For convenience of description, the total number of CSI-RS RS configurations is assumed to be 10, numbered from #1 to #10.

When 10 CSI-RS RS configurations are available as described above, the terminal A may receive one or more pieces of CSI-RS RS configuration information from the base station through higher-layer signaling. Accordingly, the terminal A may identify the configuration, as shown in Table 3, based on the CSI-RS RS configuration information included in the higher-layer signaling.

Additionally, the CSI-RS RS configuration information transmitted by the base station through higher-layer signaling may be configured in an RP-specific or SL-specific manner. The example in Table 3 may correspond to a case where the terminal A is configured and operates with four CSI-RS RS configurations.

Based on the configuration information in Table 3, the terminal A may indicate a specific CSI-RS RS to the terminal B. The indication information transmitted by the terminal A to the terminal B may be included in SCI. Alternatively, the indication information transmitted by the terminal A to the terminal B may be transmitted using a MAC-CE. In another example, the indication information transmitted by the terminal A to the terminal B may be configured through higher-layer signaling. In yet another example, the indication may be performed through a combination of two different signaling schemes.

When the terminal A indicates a CSI-RS RS #2 to the terminal B as specified in Table 3, this may imply that CSI-RS transmission resources within a given SL slot structure are transmitted in form of a time-frequency resource #1. Additionally, an identifier for the CSI-RS RS #2 in Table 3 may be indicated using an identifier ‘00’ if the configuration information has been received by both the terminal A and terminal B from the base station. In other words, the terminal A may notify the terminal B that the CSI-RS RS #2 is indicated by using SCI configured with the identifier ‘00’.

If the terminal A and terminal B are not located within the same base station, for example, if the terminal A is within a range of the base station but the terminal B is outside the range, the terminal A may provide the CSI-RS RS information configured by the base station to the terminal B in advance. Through this, the terminal A may share information on the time-frequency resources, CSI-RS transmission pattern and density, and CSI reporting type with the terminal B by using the identifier for the CSI-RS RS transmitted to the terminal B.

The present disclosure assumes a case where the terminal A and terminal B share the information in Table 3 as described above.

If the terminal A indicates the CSI-RS RS #2 in Table 3 to the terminal B, the CSI-RS transmission may use a 2-port CDM scheme with a density of 1. Therefore, when the CSI-RS RS #2 is indicated, the CSI-RS may be mapped to resources based on the corresponding configuration and transmitted to the terminal B through specific beam(s). Furthermore, when the CSI-RS RS #2 is indicated, since CSI report information is configured to include CQI and RI, it may imply that the CSI-RS transmitted by the terminal A is for CSI measurement rather than for beam management. Accordingly, the terminal B may receive and measure the CSI-RS transmitted by the terminal A. The terminal B may then report the measured CSI to the terminal A.

If the terminal A indicates the CSI-RS RS #4 in Table 3 to the terminal B, this may imply that CSI-RS transmission resources are transmitted in form of a time-frequency resource #2 within a given SL slot structure. When the terminal A indicates the CSI-RS RS #4 to the terminal B, CSI report information may be configured to include BI and BQI. Therefore, the CSI-RS transmitted by the terminal A may be implicitly indicated as CSI-RS for beam management.

If the terminal A indicates the CSI-RS RS #5 in Table 3 to the terminal B, it may correspond to a case where there is no CSI report information, or the terminal is configured to report only BQI without BI. If the configuration specifies that there is no CSI report information, the CSI-RS transmitted by the terminal A may be implicitly indicated as CSI-RS transmitted for a purpose of reception beam switching for the terminal B. Alternatively, if the terminal A indicates the CSI-RS RS #5 to the terminal B, it may correspond to a case where the terminal B reports only BQI without BI. When the terminal B is configured to report only BQI as described above, the terminal A may implicitly indicate that the terminal B is to switch its reception beam based on the BQI reported by the terminal B.

Additionally, the terminal A may configure the terminal B to report only a channel quality related to SL, BQI, according to the reception beam switching. By configuring as descried above, the terminal A may use information received from the terminal B to manage its transmission beam.

In Table 3, for the CSI-RS RS #4 and CSI-RS RS #7, the CSI reporting type includes BI. Therefore, by indicating the CSI-RS RS #4 or CSI-RS RS #7, the terminal A may implicitly indicate that the CSI-RS transmitted by the terminal A is for the purpose of transmission beam switching.

In Table 3, the CSI-RS RS #7 differs from the CSI-RS RS #4 in that the CSI reporting type includes CQI, RI, BI, and BQI. Therefore, the CSI-RS transmitted by the terminal A may be operated in a manner that indicates CSI-RS transmission through a current beam and multiple other beams.

Meanwhile, Table 3 may represent the configuration for all CSI-RSs transmitted within a single slot. Unlike Table 3, more detailed configuration information for each CSI-RS or each CSI-RS group within a single slot may also be mapped and operated.

In Table 3, when CSI-RS for beam management is transmitted, there is no indication information on whether the terminal A's beam is switched or not.

However, the configuration information may be extended to include additional indication information on whether the beam is switched.

Some of the information included in Table 3 may be indicated through SCI or MAC-CE. Therefore, when the terminal A transmits a beam to the terminal B, the terminal A may operate the CSI-RS by transmitting the identifier of Table 3 through SCI or by transmitting the identifier of Table 3 through a MAC-CE in advance.

For example, in the case of 2-port CSI-RS transmission, 1 bit may be added to the SCI to indicate beam adjustment for the transmission or reception beam. The use of this 1 bit for beam adjustment may be configured as follows:

1) When the terminal A sets the bit to ‘0’: The terminal A may use this to indicate that the CSI-RS is transmitted through different beams. In other words, the terminal A may set the bit for beam adjustment to ‘0’ when beam adjustment for the transmission beam is required.

2) When the terminal A sets the bit to ‘1’: The terminal A may use this to indicate that the CSI-RS is transmitted through the same beam. In other words, the terminal A may set the bit to ‘1’ to instruct beam adjustment for the reception beam when beam adjustment for the reception beam is required.

As described above, the 1 bit may also be used to indicate activation or deactivation. If activation/deactivation is indicated, the total number of bits may become 2. For example, the first bit may be set to ‘1’ for activation and ‘0’ for deactivation. In other words, the transmitting terminal A may operate with a combined form of an activation/deactivation bit and a bit for transmission/reception beam adjustment. In such cases, if the first bit of the 2 bits is set to ‘0’, the second bit may be ignored. However, if the first bit of the 2 bits is set to ‘1’, beam adjustment for transmission or reception may be indicated by the second bit.

Meanwhile, when transmitting CSI-RSs through multiple ports exceeding two, the exemplary embodiments and/or operational methods described above may be applied in a simplified, modified, or extended manner.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), comprising:
receiving, from a base station, information on a channel state information-reference signal (CSI-RS) resource set related to beam management;
determining a first resource and a CSI-RS pattern of a CSI-RS for beam management based on the information on the CSI-RS resource set;
configuring sidelink (SL) data and SL control information (SCI) including information related to the first resource and the CSI-RS pattern;
arranging the CSI-RS for beam management in a first slot based on the first resource and the CSI-RS pattern; and
transmitting the CSI-RS, the SL data, and the SCI to a second UE through a preconfigured transmission beam in the first slot.

2. The method according to claim 1, wherein the SCI further includes at least one of density information of the CSI-RS or information of a type of CSI report to be reported by the second UE.

3. The method according to claim 2, further comprising:
receiving, from the second UE, a beam index (BI) for a transmission beam of the first UE and beam quality information (BQI) for the transmission beam of the first UE, based on information of the type of the CSI report; and
determining whether to switch a transmission beam for transmitting data to the second UE based on the received BI and the received BQI.

4. The method according to claim 3, wherein the BQI is one of a Reference Signal Received Power (RSRP) or Layer 1 (L1)-RSRP.

5. The method according to claim 1, further comprising: receiving, from the base station, first slot configuration information including position information of symbols through which a Physical Sidelink Control Channel (PSCCH) is transmitted and position information of symbols through which a Physical Sidelink Shared Channel (PSSCH) is transmitted,
wherein the SCI indicates at least one symbol among the symbols through which the PSSCH is transmitted as the first resource.

6. The method according to claim 5, wherein when the first slot configuration information indicates that a PSCCH and the PSSCH are to be allocated together in at least one symbol of the first slot, the first resource indicated by the SCI is at least one symbol among symbols excluding symbol(s) of the PSSCH allocated together with the PSCCH.

7. The method according to claim 1, further comprising: receiving, from the base station, first slot configuration information including position information of symbols through which a PSCCH is transmitted, position information of symbols through which a PSSCH is transmitted, and position information of symbols through which the CSI-RS is transmitted,
wherein the first resource indicated by the SCI is at least one symbol among the symbols through which the CSI-RS is transmitted.

8. The method according to claim 1, wherein the information related to the CSI-RS pattern indicates at least one of code division multiplexing (CDM) of the CSI-RS, time division multiplexing (TDM) of the CSI-RS, or frequency division multiplexing (FDM) of the CSI-RS, and includes information on a number of ports through which the CSI-RS is transmitted.

9. A method of a second user equipment (UE), comprising:
receiving, from a base station, information on a channel state information-reference signal (CSI-RS) resource set related to beam management;
receiving sidelink control information (SCI) from a first UE;
measuring a first CSI-RS for beam management based on the information on the CSI-RS resource set and the SCI;
generating a beam index (BI) of a transmission beam of the first UE and beam quality information (BQI) of the transmission beam of the first UE based on the measured first CSI-RS; and
reporting the BI and the BQI to the first UE.

10. The method according to claim 9, wherein the SCI further includes at least one of information related to sidelink (SL) data, information of a first resource of the first CSI-RS, density information of the first CSI-RS, or information of a transmission pattern of the first CSI-RS.

11. The method according to claim 10, wherein the information of the transmission pattern of the first CSI-RS indicates at least one of code division multiplexing (CDM) of the first CSI-RS, time division multiplexing (TDM) of the first CSI-RS, or frequency division multiplexing (FDM) of the first CSI-RS, and includes information on a number of ports through which the first CSI-RS is transmitted.

12. The method according to claim 9, further comprising: receiving, from the base station, first slot configuration information including position information of symbols through which a Physical Sidelink Control Channel (PSCCH) is transmitted and position information of symbols through which a Physical Sidelink Shared Channel (PSSCH) is transmitted,
wherein the SCI indicates at least one symbol among the symbols through which the PSSCH is transmitted as a first resource for transmitting the first CSI-RS.

13. The method according to claim 12, wherein when the first slot configuration information indicates that a PSCCH and the PSSCH are to be allocated together in at least one symbol of the first slot, the first resource indicated by the SCI is at least one symbol among symbols excluding symbol(s) of the PSSCH allocated together with the PSCCH.

14. The method according to claim 9, further comprising: receiving, from the base station, first slot configuration information including position information of symbols through which a PSCCH is transmitted, position information of symbols through which a PSSCH is transmitted, and position information of symbols through which the first CSI-RS is transmitted,
wherein the SCI indicates at least one symbol among the symbols through which the PSSCH is transmitted as a position at which the first CSI-RS is transmitted.

15. A first user equipment (UE) comprising at least one processor, wherein the at least one processor causes the first UE to perform:
receiving, from a base station, information on a channel state information-reference signal (CSI-RS) resource set related to beam management;
determining a first resource and a CSI-RS pattern of a CSI-RS for beam management based on the information on the CSI-RS resource set;
configuring sidelink (SL) data and SL control information (SCI) including information related to the first resource and the CSI-RS pattern;
arranging the CSI-RS for beam management in a first slot based on the first resource and the CSI-RS pattern; and
transmitting the CSI-RS, the SL data, and the SCI to a second UE through a preconfigured transmission beam in the first slot.

16. The first UE according to claim 15, wherein the SCI further includes at least one of density information of the CSI-RS or information of a type of CSI report to be reported by the second UE.

17. The first UE according to claim 16, wherein the at least one processor causes the first UE to perform:
receiving, from the second UE, a beam index (BI) for a transmission beam of the first UE and beam quality information (BQI) for the transmission beam of the first UE, based on information of the type of the CSI report; and
determining whether to switch a transmission beam for transmitting data to the second UE based on the received BI and the received BQI.

18. The first UE according to claim 15, wherein the at least one processor further causes the first UE to perform: receiving, from the base station, first slot configuration information including position information of symbols through which a Physical Sidelink Control Channel (PSCCH) is transmitted and position information of symbols through which a Physical Sidelink Shared Channel (PSSCH) is transmitted,
wherein the SCI indicates at least one symbol among the symbols through which the PSSCH is transmitted as the first resource.

19. The first UE according to claim 18, wherein when the first slot configuration information indicates that a PSCCH and the PSSCH are to be allocated together in at least one symbol of the first slot, the first resource indicated by the SCI is at least one symbol among symbols excluding symbol(s) of the PSSCH allocated together with the PSCCH.

20. The first UE according to claim 15, wherein the at least one processor further causes the first UE to perform: receiving, from the base station, first slot configuration information including position information of symbols through which a PSCCH is transmitted, position information of symbols through which a PSSCH is transmitted, and position information of symbols through which the CSI-RS is transmitted,
wherein the first resource indicated by the SCI is at least one symbol among the symbols through which the CSI-RS is transmitted.
